(19) United States
(12) Patent Application Publication
(10) Pub. No.: US 2019/0066944 A1
(43) Pub. Date: Feb. 28, 2019

(54) PHYSICAL BUTTON MECHANISM AND ELECTRONIC DEVICE WITH THE SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventors: JIAN-GUO WU, Shenzhen (CN); HAO-YUAN HUANG, New Taipei (TW); CHIA-JUI HU, New Taipei (TW); YEN-YU CHEN, New Taipei (TW); CHUN-KAI PENG, New Taipei (TW); LEI HU, Shenzhen (CN); GANG-HUA LIU, Shenzhen (CN)

(21) Appl. No.: 15/870,880

(22) Filed: Jan. 13, 2018

(30) Foreign Application Priority Data
Aug. 31, 2017 (CN) 201721121140.X

(51) Int. Cl. H01H 13/14; H01H 13/04

(52) U.S. Cl. CPC H01H 13/14; H01H 13/04

(57) ABSTRACT

A physical button mechanism for an electronic device includes a casing and a button mechanism therein mounted. The button mechanism includes a connection element, at least one button, a bracket, and at least one adjusting element. The at least one button is mounted on a side of the connection element. The bracket is arranged on another side of the connection element. The at least one adjusting element is mounted on the bracket to be in contact with the connection element. The adjusting element and the connection element are adjustable to allow for sloppiness and spring fatigue over long usage, by adjusting preload sprung pressure of the button mechanism.

### CROSS-REFERENCE TO RELATED APPLICATIONS

This application claims priority to Chinese Patent Application No. 201721121140.X filed on Aug. 31, 2017, the contents of which are incorporated by reference herein.

### FIELD

The subject matter herein generally relates to mechanical devices, and particularly to a physical button mechanism and an electronic device with the physical button mechanism.

### BACKGROUND

Smart phones and tablet computers are usually configured with a number of buttons, which are used for starting or shutting down, adjusting volume, or locking and unlocking the electronic devices. However, in long-term use, the buttons become dead, or caved in, or loose.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view illustrating an exemplary embodiment of a physical button mechanism.

FIG. 2 is an exploded view illustrating an exemplary embodiment of the button mechanism in FIG. 1.

FIG. 3 is a cross section view illustrating an exemplary embodiment of the button mechanism in FIG. 1.

FIG. 4 is a schematic view of the button mechanism in a precompressed state of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” exemplary embodiment in this disclosure are not necessarily to the same exemplary embodiment, and such references mean “at least one”.

The term “comprising” means “including, but not necessarily limited to”, it specifically indicates open-ended inclusion or membership in a so-described combination, group, series, and the like.

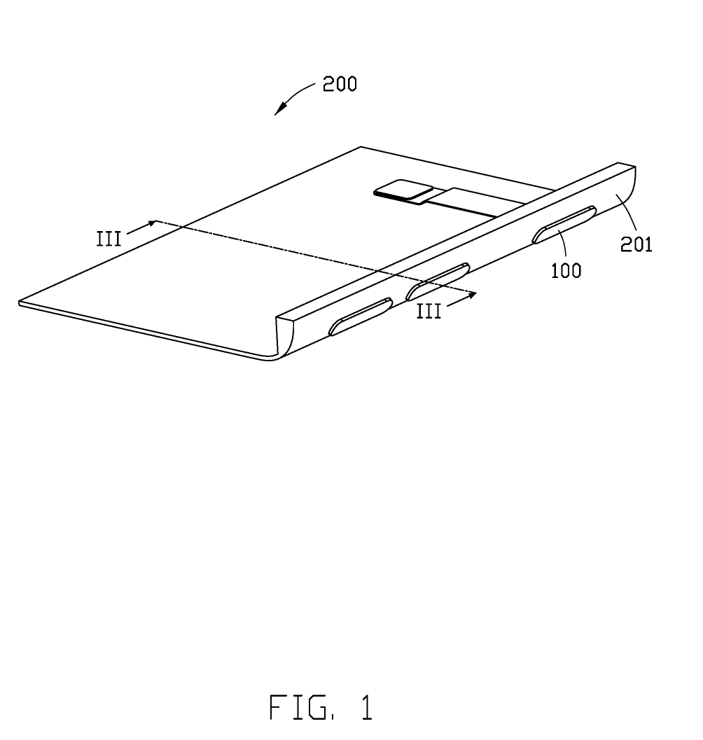

FIG. 1 illustrates an exemplary embodiment of a physical button mechanism 100. In at least one exemplary embodiment, the button mechanism 100 can be applied in an electronic device 200, the electronic device 200 can be a smart phone or a tablet computer.

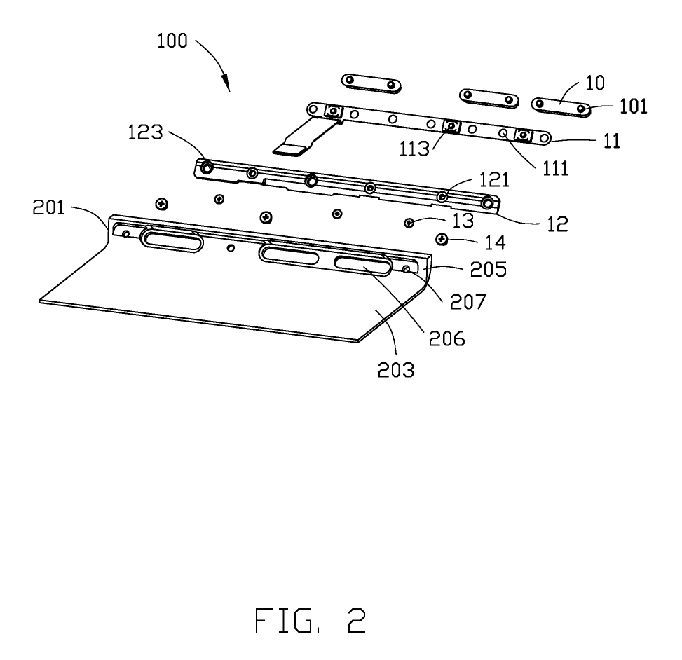

Referring to FIG. 2, the electronic device 200 includes a casing 201. The casing 201 includes a baseboard 203 and a sideboard 205. The sideboard 205 is arranged in an edge of the baseboard 203. The sideboard 205 defines an opening 206 and at least one fixing hole 207. When the button mechanism 100 is mounted on the sideboard 205, the button mechanism 100 is exposed out of the casing 201 through the opening 206.

The button mechanism 100 includes at least one button 10, a connection element 11, a bracket 12, at least one adjusting element 13, and at least one fixing element 14.

In at least one exemplary embodiment, the button 10 is for being pressed by a user. The button 10 is a board with a predetermined thickness, and includes at least one mounting member 101 on a side. In at least one exemplary embodiment, the button 10 includes two mounting members 101, arranged at the two ends of the button 10. The mounting member 101 is a bulging structure with a cylinder-shape.

The connection element 11 connects with the button 10. The connection element 11 is substantially a strip-shaped sheet. The connection element 11 defines at least one group of connection holes 111. In at least one exemplary embodiment, each group of connection holes 111 corresponds to a button 10, and a quantity of connection holes 111 in each group is equal to a quantity of the mounting members 101 on the button 10. For example, the button mechanism 100 includes three buttons 10, each button 10 includes two mounting members 101. The connection element 11 includes three groups of connection holes 111, each group of connection holes 111 includes two connection holes 111. The mounting member 101 of the button 10 passes through the connection holes 111, thus the button 10 can be mounted on the connection element 11.

In at least one exemplary embodiment, the connection element 11 further defines at least one switch unit 113. A quantity of the switch unit 113 is equal to the quantity of the button 10. Each switch unit 113 is arranged between each group of connection holes 111, and corresponds to the button 10. The connection element 11 faces away from the button 10. When being pressed, the button 10 touches the switch unit 113, thus achieving a switch function of the switch unit 113.

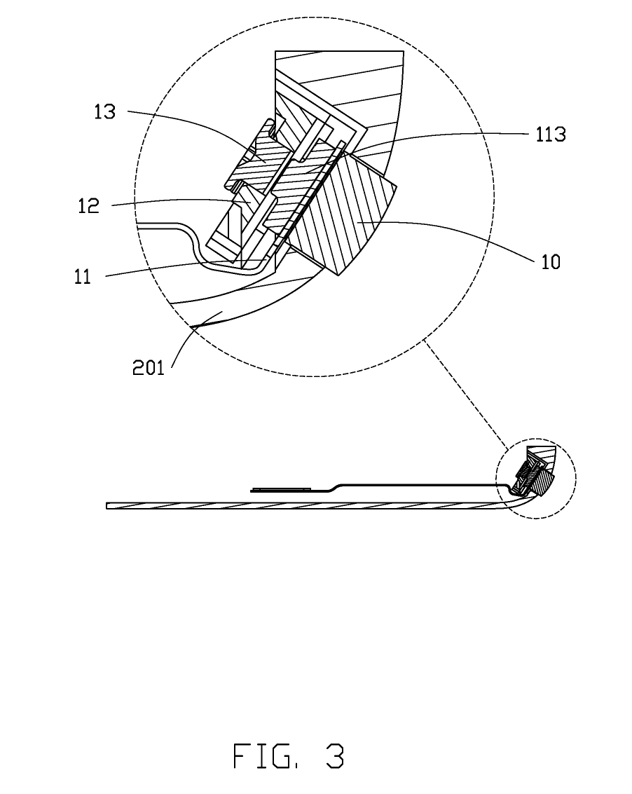

Referring to FIG. 3, the bracket 12 is used for mounting the button 10 and the connection element 11 on the casing 201. The bracket 12 is plate-shaped. The bracket 12 defines at least one adjusting hole 121. In at least one exemplary embodiment, a quantity of the adjusting hole 121 is equal to the quantity of the switch unit 113. The bracket 12 is arranged on a side close to the switch unit 113 of the connection element 11, the connection element 11 is clamped between the button 10 and the bracket 12. The adjusting hole 121 is aligned to a switch unit 113, and the adjusting element 13 passes through the adjusting hole 121. The adjusting element 13 is then in contact with the switch unit 113.

In at least one exemplary embodiment, the user can adjust a mounting depth of the adjusting element 13 in the adjusting hole 121, thus a distance between the adjusting element 13 and the switch unit 113 can be adjusted. The distance of travel of a pressed button 10 and the degree of initial resistance to the pressing can therefore be adjusted, that is, degree of precompression of the button mechanism 100 can be adjusted.

In at least one exemplary embodiment, the bracket 12 defines at least one mounting hole 123. A quantity of the mounting hole 123 is equal to the quantity of the fixing hole 207. When the fixing element 14 passes through the mounting hole 123 and the fixing hole 207, the bracket 12 is mounted in the casing 201, thus the button 10 and the connection element 11 are clamped between the sideboard 205 and the bracket 12, and the button 10 is exposed out of the opening 206.

In at least one exemplary embodiment, when assembling the button mechanism 100, the mounting member 101 of the button 10 passes through a connection hole 111, then the button 10 is mounted on the connection element 11. The bracket 12 is mounted on the side defining the switch unit 113 of the connection element 11, and the adjusting hole 121 is aligned to the corresponding switch unit 113. The adjusting element 13 passes through the corresponding adjusting hole 121, thereby the button mechanism 100 is assembled. When the fixing element 14 passes through the mounting hole 123 and the fixing hole 207, the bracket 12 is mounted on the casing 201. The button 10 and the connection element 11 are clamped between the sideboard 205 and the bracket 12, and the button 10 is exposed out of the opening 206.

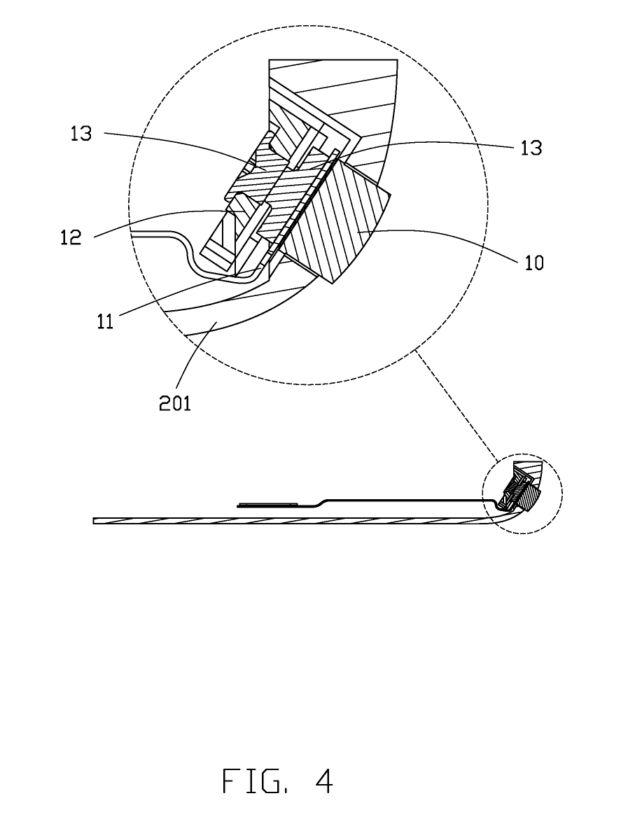

Referring to FIG. 4, when the button mechanism 100 is mounted on the casing 201, resilience for rebounding can be tested according to the distance between the adjusting element 12 and the switch unit 113 or by pressing the button 10. The mounting depth of the adjusting element 12 in the adjusting hole 121 is adjustable. Provided the adjusting element 13 is in contact with the switch unit 113, the connection element 11 can be tightly precompressed against the button 10, thus the button mechanism 100 is adjusted to have best feel when being pressed, that is, the button mechanism 100 have best degree of precompression. Then the adjusting element 13 can be mounted on the bracket 12. In at least one exemplary embodiment, the adjusting element 13 is glued on the bracket 12.

The button mechanism 100 has a relatively simple structure. When the mounting depth of the adjusting element 13 in the adjusting hole 121 is changed, the distance between the adjusting element 13 and the switch unit 113 is adjusted, that is, the degree of precompression can be effectively adjusted, thus preventing the button mechanism 100 becoming loose or sloppy in operation.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A physical button mechanism comprising:
a connection element;
at least one button mounted on one side of the connection element;
a bracket arranged on the other side of the connection element; and
at least one adjusting element mounted on the bracket and in contact with the connection element, wherein when a distance between the at least one adjusting element and the connection element is changed by a user, degree of precompression of the button mechanism is adjusted.

2. The physical button mechanism according to claim 1, wherein at least one mounting member is arranged on a side of the at least one button, the connection element defines at least one group of connection holes, the mounting member passes through the at least one group of connection holes, and mounts the button on the connection element.

3. The physical button mechanism according to claim 1, wherein the connection element further comprises at least one switch unit, the at least one switch unit is arranged on a side of the connection element away from the button.

4. The physical button mechanism according to claim 3, wherein the bracket defines at least one adjusting hole, the adjusting hole is aligned to the at least one switch unit, the adjusting element is in contact with the switch unit, when a mounting depth of the adjusting hole in the adjusting element is adjusted by the user, the degree of precompression of the button mechanism is adjusted.

5. An electronic device comprising:
a casing; and
a physical button mechanism mounted on the casing, comprising:
a connection element;
at least one button mounted on one side of the connection element;
a bracket arranged on the other side of the connection element; and
at least one adjusting element mounted on the bracket and in contact with the connection element, wherein when a distance between the at least one adjusting element and the connection element is changed by a user, degree of precompression of the button mechanism is adjusted.

6. The electronic device according to claim 5, wherein at least one mounting member is arranged on a side of the at least one button, the connection element defines at least one group of connection holes, the mounting member passes through the at least one group of connection holes, and mounts the button on the connection element.

7. The electronic device according to claim 5, wherein the connection element further comprises at least one switch unit, the at least one switch unit is arranged on a side of the connection element away from the button.

8. The electronic device according to claim 7, wherein the bracket defines at least one adjusting hole, the adjusting hole is aligned to the at least one switch unit, the adjusting element is in contact with the switch unit, when a mounting depth of the adjusting hole in the adjusting element is adjusted by the user, the precompressed force of the button mechanism is adjusted.

9. The electronic device according to claim 5, wherein the button further comprises a fixing element, the bracket defines at least one mounting hole, the casing defines at least one fixing hole, the fixing element passes through the mounting hole and the fixing hole, and mounts the button mechanism on the casing.

10. The electronic device according to claim 5, wherein the casing defines an opening, when the button mechanism is mounted on the casing, the button mechanism is exposed out of the casing through the opening.
